(19) United States
(12) Patent Application Publication
(10) Pub. No.: US 2024/0324037 A1
(43) Pub. Date: Sep. 26, 2024

(54) LOCAL BREAKOUT FOR MULTI-ACCESS EDGE COMPUTING USING A DEDICATED BEARER

(71) Applicant: Nokia Solutions and Networks Oy, Espoo (FI)

(72) Inventors: Praveen MULEY, Sunnyvale, CA (US); Sajiv SELVARAJ, Sunnyvale, CA (US); Kiran MUNDLA, Sunnyvale, CA (US); Sudeep PATWARDHAN, Mountain View, CA (US)

(21) Appl. No.: 18/261,184

(22) PCT Filed: Jan. 15, 2021
(86) PCT No.: PCT/US2021/013563

§ 371 Date: Jul. 12, 2023

(51) Int. Cl. H04W 76/12; H04L 43/08; H04W 76/22

(52) U.S. Cl. CPC H04W 76/12; H04L 43/08; H04W 76/22

(57) ABSTRACT

A gateway establishes a local breakout (LBO) bearer concurrently with one or more bearers associated with a communication session involving a user equipment. The gateway selectively routes packets associated with the user equipment to the LBO bearer or the one or more bearers associated with the communication session based on one or more LBO rules implemented at the gateway. In some cases, the LBO rules are based on one or more of a quality of service (QoS) class identifier (QCI), a QoS flow identifier (QFI), and an uplink classifier (ULCL) associated with packets received by the gateway. Uplink packets from the user equipment are routed to a local application via the LBO bearer in response to one or more of the LBO rules being satisfied. Otherwise, uplink packets are routed to an external network via the one or more bearers associated with the communication session.

### BACKGROUND

Traffic is conveyed between entities in wireless communication networks via one or more bearers that are associated with (or bound to) the traffic flows. In Fourth Generation (4G) networks, traffic is conveyed between user equipment and servers in the network over a dedicated bearer that is established between the user equipment and a packet data network (PDN) gateway (PGW) that provides connectivity to external packet data networks. The dedicated bearers are associated with capacities, latencies, and packet loss rates, which are indicated by a quality of service (QoS) class identifier (QCI). In Fifth Generation (5G) networks, traffic is conveyed between the user equipment and servers in the network over a session that is established between user equipment and a user plane function (UPF). The session supports one or more flows that use one or more radio bearers to convey packets between the user equipment and a base station (e.g., a node B, eNB, or gNB) and a tunnel to convey packets between the node B and the UPF. The flows between the user equipment and the UPF are provided at a QoS that is indicated by a QoS flow identifier (QFI) for the flow. The PGW (in 4G) or the UPF (in 5G) also perform functions such as paging, lawful intercept, charging, and collection of usage statistics are performed based on the bearer traffic.

### SUMMARY OF EMBODIMENTS

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In some embodiments, a method is provided. Some embodiments of the method include establishing a local breakout (LBO) bearer at a gateway. The LBO bearer operates concurrently with at least one bearer associated with a communication session involving a user equipment. The method also includes selectively routing packets associated with the user equipment to the LBO bearer or the at least one bearer associated with the communication session based on at least one LBO rule implemented at the gateway.

In some embodiments, the LBO bearer and the at least one bearer associated with the communication session are identified by the same tunnel endpoint identifier (TEID) or QoS flow identifier (QFI).

In some embodiments, the gateway is a serving gateway (SGW) and the communication session is a packet data network (PDN) session, the PDN session is terminated by the user equipment and a PDN gateway (PGW), and establishing the LBO bearer includes establishing the LBO bearer in a user plane bearer implemented in a user plane SGW.

In some embodiments, the gateway is a user plane function (UPF) and the communication session is a packet data unit (PDU) session.

In some embodiments, establishing the LBO bearer includes establishing the LBO bearer as a user plane bearer implemented in the UPF that is associated with a radio access network that serves the user equipment.

In some embodiments, establishing the LBO bearer includes establishing the LBO bearer in response to detecting a forwarding action rule that indicates the UPF and an interface.

In some embodiments, establishing the LBO bearer includes establishing the LBO bearer as a control plane bearer implemented in a system management function (SMF) that is associated with the UPF.

In some embodiments, establishing the LBO bearer includes configuring the LBO bearer with at least one LBO rule that is determined based on matching criteria for at least one of a list of mobile country codes/mobile network codes (MCC/MNC) and a data network access identifier (DNAI).

In some embodiments, establishing the LBO bearer includes mapping an access point name (APN) to the LBO bearer based on the at least one of the list of MCC/MNC and the DNAI.

Some embodiments of the method include determining whether the at least one LBO rule is satisfied for at least one packet.

In some embodiments, determining whether the at least one LBO rule is satisfied includes determining whether the at least one LBO rule is satisfied based on at least one of a quality of service (QoS) class identifier (QCI), a QoS flow identifier (QFI), and an uplink classifier (ULCL) associated with the at least one packet.

In some embodiments, selectively routing packets includes receiving a first set of uplink packets from the user equipment and routing the first set of uplink packets to a local application via the LBO bearer in response to the first set of packets satisfying the at least one LBO rule.

In some embodiments, selectively routing packets includes receiving a second set of uplink packets from the user equipment and routing the second set of uplink packets to an external network via the at least one bearer associated with the communication session in response to the second set of packets not satisfying the at least one LBO rule.

In some embodiments, selectively routing packets includes receiving downlink packets from the local application and routing the downlink packets towards the user equipment via the LBO bearer in response to the downlink packets satisfying the at least one LBO rule.

Some embodiments of the method include generating, using the LBO bearer, at least one charging data record (CDR) based on packets selectively routed to the LBO bearer.

In some embodiments, establishing the LBO bearer at the gateway includes establishing an override charging profile for the LBO bearer for generating the at least one CDR for traffic conveyed by the LBO bearer, wherein the at least one CDR is generated for at least one of a bearer, a rule, or a rating group of rules.

In some embodiments, a gateway is provided. The gateway includes a processor configured to establish a local breakout (LBO) bearer that operates concurrently with at least one bearer associated with a communication session involving a user equipment. The processor is configured to selectively route packets associated with the user equipment to the LBO bearer or the at least one bearer associated with the session based on at least one LBO rule implemented at the gateway.

In some embodiments, the LBO bearer and the at least one bearer associated with the communication session are identified by the same tunnel endpoint identifier (TEID).

In some embodiments, the gateway is a serving gateway (SGW) and the communication session is a packet data network (PDN) session, the PDN session is terminated by the user equipment and a PDN gateway (PGW), and the processor is configured to establish the LBO bearer in a user plane bearer implemented in a user plane SGW.

In some embodiments, the gateway is a user plane function (UPF) and the communication session is a packet data unit (PDU) session.

In some embodiments, the processor is configured to establish the LBO bearer as a user plane bearer implemented in the UPF that is associated with a radio access network that serves the user equipment.

In some embodiments, the processor is configured to establish the LBO bearer in response to detecting a forwarding action rule that indicates the UPF and an interface.

In some embodiments, establishing the LBO bearer includes establishing the LBO bearer as a control plane bearer implemented in a system management function (SMF) that is associated with the UPF.

In some embodiments, the processor is configured to configure the LBO bearer with at least one LBO rule that is determined based on matching criteria for at least one of a list of mobile country codes/mobile network codes (MCC/MNC) and a data network access identifier (DNAI).

In some embodiments, the processor is configured to map an access point name (APN) to the LBO bearer based on the at least one of the list of MCC/MNC and the DNAI.

In some embodiments, the processor is configured to determine whether the at least one LBO rule is satisfied for at least one packet.

In some embodiments, the processor is configured to determine whether the at least one LBO rule is satisfied based on at least one of a quality of service (QoS) class identifier (QCI), a QoS flow identifier (QFI), and an uplink classifier (ULCL) associated with the at least one packet.

Some embodiments of the gateway include a transceiver configured to receive a first set of uplink packets from the user equipment and the processor is configured to route the first set of uplink packets to a local application via the LBO bearer in response to the first set of packets satisfying the at least one LBO rule.

In some embodiments, the transceiver is configured to receive a second set of uplink packets from the user equipment, and wherein the processor is configured to route the second set of uplink packets to an external network via the at least one bearer associated with the communication session in response to the second set of packets not satisfying the at least one LBO rule.

In some embodiments, the transceiver is configured to receive downlink packets from the local application, and wherein the processor is configured to route the downlink packets towards the user equipment via the LBO bearer in response to the downlink packets satisfying the at least one LBO rule.

In some embodiments, the processor is configured to generate, using the LBO bearer, at least one charging data record (CDR) based on packets selectively routed to the LBO bearer.

In some embodiments, the processor is configured to establish an override charging profile for the LBO bearer for generating the at least one CDR for traffic conveyed by the LBO bearer, wherein the at least one CDR is generated for at least one of a bearer, a rule, or a rating group of rules.

In some embodiments, an apparatus is provided that includes at least one processor and at least one memory including computer program code. The at least one memory and the computer program code are configured to, with the at least one processor, cause the apparatus at least to perform establishing a local breakout (LBO) bearer at a gateway concurrently with at least one bearer associated with a communication session involving a user equipment and selectively routing packets associated with the user equipment to the LBO bearer or the at least one bearer associated with the communication session based on at least one LBO rule implemented at the gateway.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a first embodiment of a Fourth Generation (4G) communication system that implements a dedicated local breakout (LBO) bearer for multi-access edge computing (MEC) according to some embodiments.

FIG. 2 is a block diagram of a second embodiment of a 4G communication system that implements an LBO bearer for MEC according to some embodiments.

FIG. 3 is a block diagram of a portion of a 4G communication system that implements control-user plane separation (CUPS) according to some embodiments.

FIG. 4 is a block diagram of an LBO architecture that is implemented in a 4G communication system according to some embodiments.

FIG. 5 is a block diagram of a Fifth Generation (5G) communication system that implements an LBO bearer for MEC according to some embodiments.

FIG. 6 is a block diagram of an LBO architecture that is implemented in a 5G communication system according to some embodiments.

FIG. 7 is a flow diagram of a method of selectively routing packets to an LBO bearer or a default bearer according to some embodiments.

FIG. 8 is a block diagram of a network function virtualization (NFV) architecture that supports LBO offload for MEC according to some embodiments.

### DETAILED DESCRIPTION

Multi-access edge computing (MEC) is a network architecture that enables cloud computing capabilities at or near the edge of a network. Thus, MEC moves application hosting from centralized data centers to the network edge and closer to the user of the application. MEC technology is implemented at base stations or other edge nodes such as the serving gateway (SGW) in 4G networks and the UPF in 5G networks. Deploying applications at or near the edge of the network enables flexible and rapid deployment of new applications and services for customers, as well as reducing network congestion and improving performance. For example, gaming applications typically require very low latencies and high bandwidth efficiencies, which cannot always be achieved if the traffic associated with the gaming application is sent to an external packet data network via the PGW. Instead, traffic for the gaming application can be offloaded to MEC applications implemented at or near the edge of the network. The traffic associated with the MEC applications is separated, offloaded, or broken out from the main traffic flow destined for servers in the external packet data network.

Local breakout (LBO) rules are implemented in the user plane and used to selectively route packets to a local (edge) application or an external packet data network. In 4G networks, the LBO rules are implemented at the SGW, which selectively directs traffic to a local (edge) application or the PGW that anchors the corresponding PDN session based on the LBO rules. In 5G networks, the LBO rules are implemented based on an uplink classifier (ULCL) having a value that indicates whether the traffic is offloaded to a local UPF (e.g., a UPF implemented close to the corresponding radio access network, RAN) or conveyed over an N9 interface to a UPF at a centralized location that anchors a corresponding packet data unit (PDU) session. However, there are several drawbacks to conventional LBO techniques implemented in 4G or 5G networks. For example, charging is performed at the PGW (in 4G) or the UPF (in 5G) based on traffic that is conveyed via a dedicated bearer (or corresponding tunnel) established between the user equipment and the PGW or UPF. The LBO traffic is not charged independently of the non-breakout traffic and in some cases may not be billed at all if it does not traverse the PGW/UPF. For another example, usage statistics are also collected based on traffic conveyed via the PDN/PDU bearer and may therefore not accurately reflect usage associated with the LBO rules.

FIGS. 1-8 disclose embodiments of local breakout (LBO) for MEC that are implemented without the disadvantages of the conventional practice (e.g., inflexible charging rules and poor data collection) by establishing an LBO bearer at a gateway. The LBO bearer operates concurrently with conventional bearers (or tunnels) associated with a PDN session (in 4G) or a PDU session (in 5G). In some embodiments, the gateway is a serving gateway (SGW) or a user plane function (UPF). The LBO bearer uses the same identifiers as the conventional bearers, e.g., the LBO bearer and the bearers in the PDN session are identified by the same tunnel endpoint identifier (TEID). The LBO bearer can be a user plane bearer implemented in a user plane SGW (SGW-U) in a 4G network that implements control/user plane separation (CUPS). The LBO bearer can also be a user plane bearer implemented in a UPF that is proximate the radio access network (RAN) that serves the user equipment. The gateway selectively routes packets to the LBO bearer or the conventional bearer based on LBO rules. For example, the gateway can use the LBO rules to determine that one set of uplink packets received from the user equipment via a radio bearer should be routed to a local application via the LBO bearer and a corresponding interface. The gateway can also use the LBO rules to determine that another set of uplink packets received from the user equipment via the radio bearer should be routed to an external packet data network via the conventional bearer and a corresponding interface. In some embodiments, the LBO rules are determined based on characteristics of the traffic indicated by a quality of service (QoS) class identifier (QCI), a QoS flow identifier (QFI), an uplink classifier (ULCL), and the like. The LBO bearer directs downlink packets to the corresponding conventional bearers associated with the session, e.g., by merging the packets back into the PDN bearer to be conveyed to the user equipment. In some embodiments, the LBO bearer rules are therefore used to model the operation of the LBO bearer to operate as a PGW bearer.

Implementing the LBO bearer provides several advantages over conventional LBO routing techniques. For example, delay sensitive traffic can be offloaded to local MEC applications via the LBO bearer and non-delay sensitive traffic can be allowed to proceed to the network via the PDN bearer. For another example, a ULCL included in packet flows processed by the first entity can be matched against the LBO rules so that traffic matching the LBO rules exits locally to the Internet or a virtual private network (VPN) via the LBO bearer and traffic that does not match the LBO rules is sent to the anchor of the PDN bearer, e.g., a PGW or UPF. The LBO bearer can also apply LBO rules policies that apply different levels of throttling to different flows. In some embodiments, an override charging profile is configured for the LBO bearer and the PGW generates a charging data record (CDR) for the LBO bearer, which allows service providers to charge separately for MEC services or applications. Seamless interworking between 4G and 5G networks during handover of user equipment that are utilizing LBO services is supported by the LBO bearer because the 4G and 5G systems use common program modeling constructs. For example, location-based policies are implemented using common programming constructs based on an access point name (APN) in 4G and a data network access identifier (DNAI) in 5G.

FIG. 1 is a block diagram of a first embodiment of a Fourth Generation (4G) communication system 100 that implements a dedicated local breakout (LBO) bearer for multi-access edge computing (MEC) according to some embodiments. The 4G communication system 100 includes one or more base stations 105 (e.g., e-node Bs, radio access networks (RANs), access points, and the like) that provide wireless connectivity to one or more user equipment 110. The 4G communication system 100 provides applications to the user equipment 110 and MEC is used to move application hosting from centralized data centers to the network edge.

In the illustrated embodiment, the 4G communication system 100 includes a serving gateway (SGW) 115 that routes and forwards user data packets on the uplink and downlink. The SGW 115 also act as a mobility anchor for the user plane during handovers between base stations 105. When the user equipment 110 is in the idle state, the SGW 115 terminates the downlink data path to user equipment 110 and triggers paging when downlink data arrives for the idle user equipment 110. The SGW 115 also manages and stores contexts for the user equipment 110 including parameters of IP bearer services, network internal routing information, and the like.

The PGW 120 provides connectivity between the user equipment 110 and one or more external packet data networks. The PGW 120 provides charging support for the user equipment 110, e.g., by generating charging data records (CDR) based on uplink packets transmitted by the user equipment 110 and downlink packets received by the user equipment 110. The PGW 120 also performs policy enforcement, packet filtering, lawful interception, and packet screening.

An MEC module 125 host applications that are provided to the user equipment 110 via the base station 105. Some embodiments of the MEC module 125 are implemented as a separate device and corresponding hardware, firmware, or software. Other embodiments of the MEC module 125 are implemented in the base station 105 or the SGW 115. The MEC module 125 establishes an LBO bearer that operates concurrently with one or more PDN bearers that are established as part of the PDN session between the user equipment 110 and the PGW 120. The MEC module 125 selectively routes or steers packets associated with the user equipment 110 to the LBO bearer or the one or more bearers associated with the PDN session based on one or more LBO rules implemented at the MEC module 125. In some embodiments, the LBO rules are based on one or more of a quality of service (QoS) class identifier (QCI), a QoS flow identifier (QFI), and an uplink classifier (ULCL) associated with packets received by the MEC module 125. Uplink packets from the user equipment 110 are routed to a local application via the LBO bearer in response to one or more of the LBO rules being satisfied. Otherwise, uplink packets are routed to an external network via PGW 120 using the one or more bearers associated with the PDN session. Similarly, downlink packets from a local application are steered to the MEC module 125 and the user equipment 110 according to the LBO rules associated with the LBO bearer. Implementing the LBO bearer at the MEC module 125 also supports other functionality and provides other advantages, as discussed herein.

In some embodiments, the downlink next hop of the LBO bearer is determined by the default bearer (e.g., a PGW bearer) and the uplink next hop points to a network interface such as a virtual private network (VPN) interface (Gi VR). One or more policy rules are associated with the LBO bearer. In the uplink direction, traffic arrives on the default bearer and bearer binding verification is performed by running all policy rules across the PDN session. If the traffic matches the LBO rules implemented by the LBO bearer in the SGW, then the traffic is forwarded using uplink next hop over the VPN associated with the LBO bearer. In the downlink direction, packets arrive via the VPN Gi context, which results in bearer binding of the LBO rules for the LBO bearer. The TEID associated with the bearer (e.g., the TEID of the base station 105 associated with the default bearer) is used to identify the endpoints. The packet is forwarded to the next hop in the downlink direction towards the base station associated with the PDN session.

In some embodiments, the bearer is identified using other information if a default policy rule associated with the default bearer used to forward the traffic does not match the LBO bearer while doing bearer binding or bearer binding verification. For example, if the rule matched during a bearer binding verification is a default policy, then the bearer is found using bearer bits in the TEID signalled by the GW. If a ULCL is signalled, the QFI in retained if the default rule policy is matched and then the traffic forwarded over N9 to original PSA anchor.

The LBO rules for an LBO bearer can be configured based on policies generated by a service provider such as Verizon or T-Mobile. For example, the service provider can offer an LBO service to the user equipment 110 via the MEC 125 if the user equipment 110 is associated with a different service provider but is roaming into an area served by the service provider that provides the LBO service via the MEC 125. The policies used to configure the LBO bearer can include charging policies for the service provider via the MEC 125 so that so that real time charging or generation of charging data records (CDR) is performed for traffic associated with the LBO service. In some embodiments, the APN for the service provider is associated with the LBO APN by having matching criteria such as a list of mobile country codes/mobile network codes (MCC MNC) with an APN signalled in a request message exchange during configuration of the LBO bearer. Mapping the APN to the LBO bearer assists in deriving the properties that can be configured on the APN, as well as assisting in mapping the VPN or VR in data-plane that is associated with the LBO.

In some embodiments, a data network access identifier (DNAI) is used to configure LBO rules corresponding to rules associated with a virtual router or data plane indicated by the DNAI. Mapping the LBO bearer to an APN associated with the DNAI also helps in deriving the configuration and VPN, VR mapping in data-plane in a given UPF or SGW-U. This approach supports dynamic creation and configuration of the LBO rules for an LBO bearer.

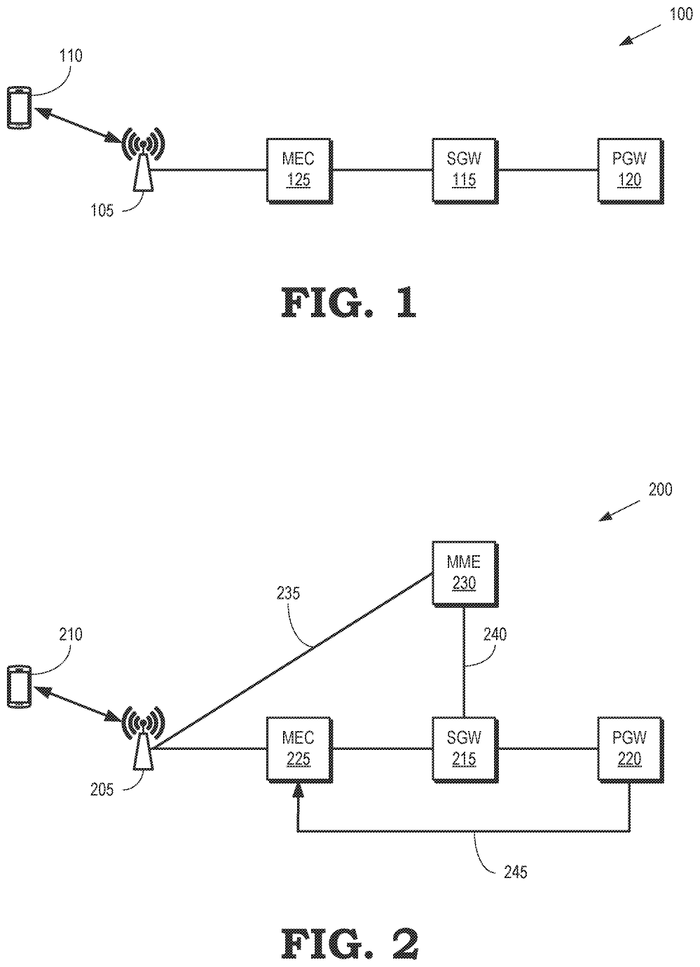

FIG. 2 is a block diagram of a second embodiment of a 4G communication system 200 that implements an LBO bearer for MEC according to some embodiments. The 4G communication system 200 includes one or more base stations 205, user equipment 210, SGW 215, PGW 220, and an MEC module 225. These entities operate in a manner that is similar or analogous to operation of the corresponding entities in the first embodiment of the 4G communication system 100 shown in FIG. 1. The second embodiment of the 4G communication system 200 also includes a mobility management entity (MME) 230 that implements protocol stacks to support interfaces 235, 240 with the base station 105 and the SGW 215, respectively. The interface 235 supports Internet protocol (IP), stream control transmission protocol (SCTP), and the S1 Application Part (S1AP) protocol. The interface 240 supports IP, user datagram protocol (UDP), and the general packet radio service (GPRS) tunneling protocol (GTP) including GTP-C to convey control signaling and GTP-U to convey user data.

The second embodiment of the 4G communication system 200 differs from the first embodiment by allowing the PGW 220 to at least partially control operation of the MEC module 225 via a reference point 245 that supports session management functionality. embodiments of the PGW 220 control operation of the MEC module 225 by exchanging messages over the reference point 245 between the PGW 220 and the MEC module 225. As discussed herein, the MEC module 225 establishes an LBO bearer that operates concurrently with one or more PDN bearers that are established as part of the PDN session between the user equipment 210 and the PGW 220. The MEC module 225 selectively routes packets associated with the user equipment 110 to the LBO bearer or the one or more bearers associated with the PDN session based on one or more LBO rules implemented at the MEC module 225. The PGW 220 performs session management via the reference point 245 to create, update, or delete context information for the user equipment 210 and provide LBO rules to the MEC module 225 for the user equipment 210. Examples of the LBO rules provided to the MEC module 225 via the reference point 245 include charging characteristics, legal intercept information, and the like.

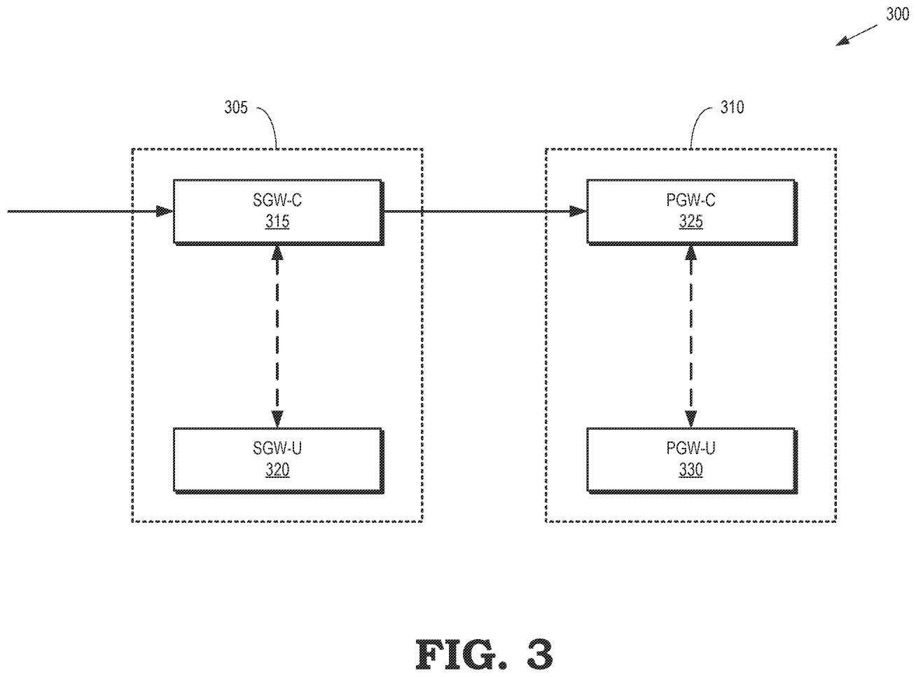

FIG. 3 is a block diagram of a portion of a 4G communication system 300 that implements control-user plane separation (CUPS) according to some embodiments. The portion of the 4G communication system 300 includes SGW functionality 305 and PGW functionality 310. In the illustrated embodiment, the SGW functionality 305 is partitioned into a control plane entity (SGW-C) 315 and a user plane entity (SGW-U) 320. The PGW functionality 310 is partitioned into a control plane entity (PGW-C) 325 and a user plane entity (PGW-U) 330. In some embodiments, control plane entities SGW-C 315 and PGW-C 325 are implemented in a centralized location, while the user plane entities SGW-U 320 and PGW-U 330 are implemented at the edge of the 4G communication system 300, which is closer to the user equipment served by the 4G communication system 300. Some embodiments of the SGW-U 320 implement an LBO bearer so that the SGW-U 320 selectively routes packets to local applications (e.g., in an MEC module implemented by the SGW-U 320 or associated base station) or to an external network via the PGW-U 330.

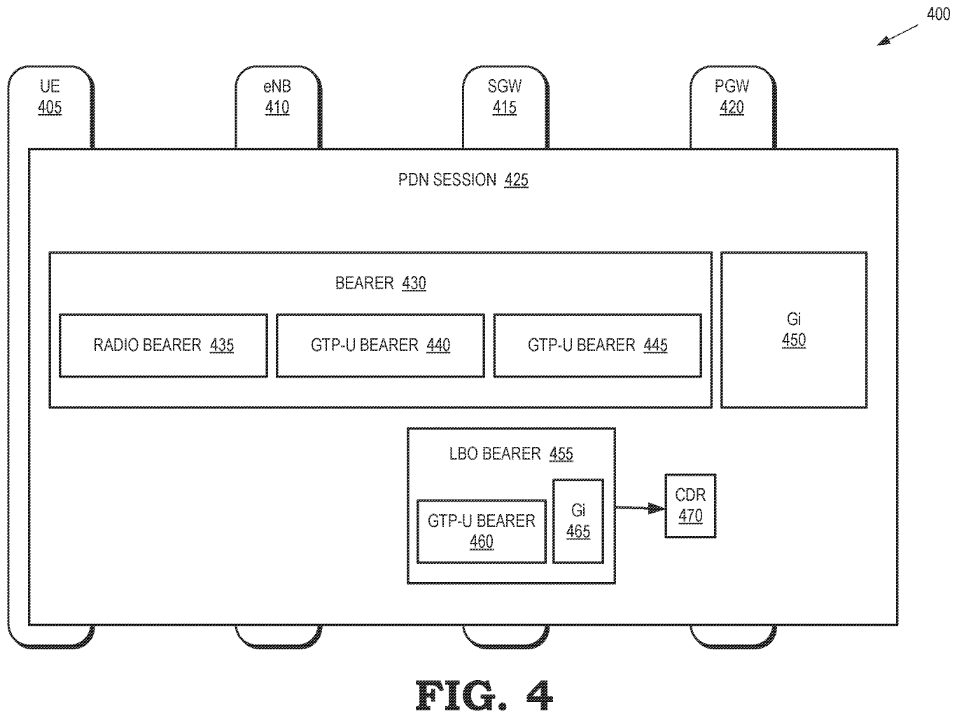

FIG. 4 is a block diagram of an LBO architecture 400 that is implemented in a 4G communication system according to some embodiments. The LBO architecture 400 is implemented in some embodiments of the 4G communication systems 100, 200, 300 shown in FIGS. 1-3. The LBO architecture 400 includes user equipment 405, a base station (eNB) 410, an SGW 415, and a PGW 420 that provides connectivity to one or more external networks. A PDN session 425 is established between the user equipment 405 and the PGW 420 to provide data connectivity for services associated with an access point name (APN). Some embodiments of the PDN session 425 are identified using a unique identifier of the user equipment 405 such as an international mobile subscriber identity (IMSI) and an identifier of the PGW 420 such as an APN. The PDN session 425 is assigned an IP address at the PGW 420 from a virtual private network (VPN) associated with the APN. Thus, the PDN session 425 is identified by the IP address in the data plane.

The PDN session 425 supports one or more bearers 430, although only one bearer 430 is shown in FIG. 4 in the interest of clarity. The bearer 430 is mapped to a radio bearer 435 that conveys information between the user equipment 405 and the base station 410. User data packets are mapped to the radio bearer 430 by the user equipment 405 (for the uplink) and the PGW 420 (for the downlink). The bearer 430 also supports a GTP-U bearer 440 between the base station 410 and the SGW 415 and a GTP-U bearer 445 between the SGW 415 and the PGW 420. The PDN session 425 also includes an interface 450 such as a Gi interface to an external PDN network.

An LBO bearer 455 is instantiated by the SGW 415. In the illustrated embodiment, the LBO bearer 455 is a unique bearer that is only known to the SGW 415. The LBO bearer 455 is known to the control plane and data plane of the SGW 415 or, in embodiments that support CUPS, the LBO bearer 455 is known to the SGW-C and the corresponding user plane (SGW-U). The LBO bearer 455 is not known to other elements in the 4G communication system 400. For example, the LBO bearer 455 is not known to the user equipment 405, the base station 410, or the PGW 420. Some embodiments of the LBO bearer 455 implement a GTP-U bearer 460 and a corresponding interface 465 such as a Gi interface. Uplink packets received on a default bearer, such as the GTP-U bearer 440, are bearer bound by the LBO bearer 455 and transmitted over the interface 465 according to a Gi context of an APN of the LBO. Downlink packets received on the APN of the LBO are bearer bound and transmitted out of the LBO bearer 455. In the illustrated embodiment, the LBO bearer 455 uses the same downlink TEID as the default bearer.

The SGW 415 can therefore selectively route packets to an external network via the default bearer 430 or to local applications via the LBO bearer 455, e.g., based on one or more LBO rules implemented in the SGW 415. The LBO bearer 455 implements the same or similar properties as the bearer 430. Some embodiments of the LBO bearer 455 therefore perform charging functions such as generating a CDR 470, legal intercept, and the like. For example, the LBO bearer 455 can generate a CDR 470 that includes information that is used to charge a user for local service or applications implemented in an MEC module. As discussed herein, packets that are not transmitted via the PGW 420 (such as LBO packets) are not included in the CDR that are generated by the PGW 424 packets that are conveyed between the user equipment 405 and an external network. The LBO bearer 455 also supports first packet triggering and the collection of statistics at a granularity corresponding to the LBO rules implemented in the SGW 415.

As discussed herein, the LBO bearer 455 is configured with LBO rules that identify traffic to be conveyed by the LBO bearer 455, e.g., by performing matching of the traffic and the rules. The LBO bearer 455 can collect statistics based on the matched rules, e.g., to handle charging for conveying the traffic. The LBO bearer 455 can collect the statistics at a bearer level, a rule level, or (if one or more rules are aggregated into a rating group) a rating group level. In some embodiments, LBO rules defined for the LBO bearer 455 support the use of an override charging profile that allows the LBO bearer 455 to generate PGW CDRs associated with bearers, rules, or rating groups associated with the uplink and downlink traffic conveyed by the LBO bearer 455.

Some embodiments of the LBO bearer 455 act as a PGW barrier, which allows the PDN session 425 to support bearers of different gateway types or properties. In some embodiments, the LBO APN is mapped either by configuring the list of mission-critical communication (MCC) mobile network codes (MNC) that match the IMSI MCC or MNC+APN signalled in messages such as a CSrequest or SMContextSetupRequest DNN and then generating the mapping of the LBO APN.

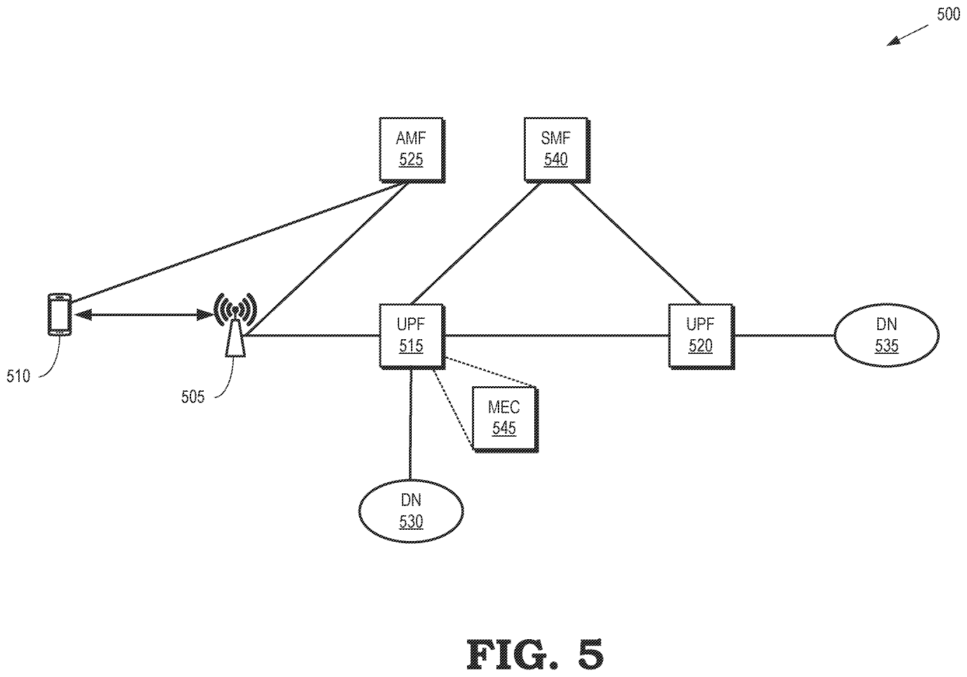

FIG. 5 is a block diagram of a Fifth Generation (5G) communication system 500 that implements an LBO bearer for MEC according to some embodiments. The 5G communication system 500 includes one or more base stations 505 (e.g., g-node Bs) that provide wireless connectivity to one or more user equipment 510. The base station 505 performs radio resource management functions including radio bearer control, radio admission control, and connection mobility control. The base station 505 also routes user plane data towards one or more user plane functions (UPF) 515, 520. The base station 505 also routes control plane information towards an access and mobility management function (AMF) 525. The 5G communication system 500 provides applications to the user equipment 510 and MEC is used to move application hosting from centralized data centers to the network edge.

The UPF 515, 520 are the points of interconnect between PDU sessions and corresponding data networks 530, 535. In the illustrated embodiment, the data network 530 is a local data network to the base station 505 and the user equipment 510. The data network 535 is a central data network to the base station 505 and the user equipment 510. Concurrent access is provided to the local data network 530 and the central data network 535 by a single PDU session. The UPF 515, 520 also perform packet inspection traffic usage reporting and support uplink classifiers for routing traffic flows to the corresponding data networks 530, 535. The AMF 525 is a termination point for non-access stratum (NAS) signaling with the user equipment 510. The AMF 525 also supports security protocols and performs access authentication and authorization, among other functions. The 5G communication system 500 also includes a session management function (SMF) 540 that performs session management, IP address allocation and management for the user equipment 510, selection and control of the UPF 515, 520, as well as other functions.

In the illustrated embodiment, the UPF 515 implements an MEC module 545 that supports applications provided to the user equipment 510 via the base station 505. The UPF 515 instantiates an LBO bearer to operate concurrently with one or more bearers or tunnels associated with a PDU session. The UPF 515 selectively routes packets associated with the user equipment 510 to the LBO bearer or the one or more bearers associated with the PDU session based on one or more LBO rules implemented at the UPF 515. For example, packets can be selectively routed to the LBO bearer or a bearer associated with the PDU session based on an ULCL included in the packets. In some embodiments, the SMF 540 programs policies or rules for network instances that are associated with corresponding DNAIs. The SMF 540 can create an internal LBO bearer for control plane traffic associated with one of the network instances managed by the SMF 540. The internal LBO bearer is associated with a DNAI and the SMF 540 generates CDRs for the control plane traffic conveyed by the LBO bearer. In some cases, the rules indicate traffic endpoints. For example, a forwarding action rule can point to the UPF 515 and a Gi interface such as the Gi interfaces 450, 465 shown in FIG. 4. In response to receiving the rule, the UPF 515 instantiates an LBO bearer in the user plane to selectively route packets, as discussed herein.

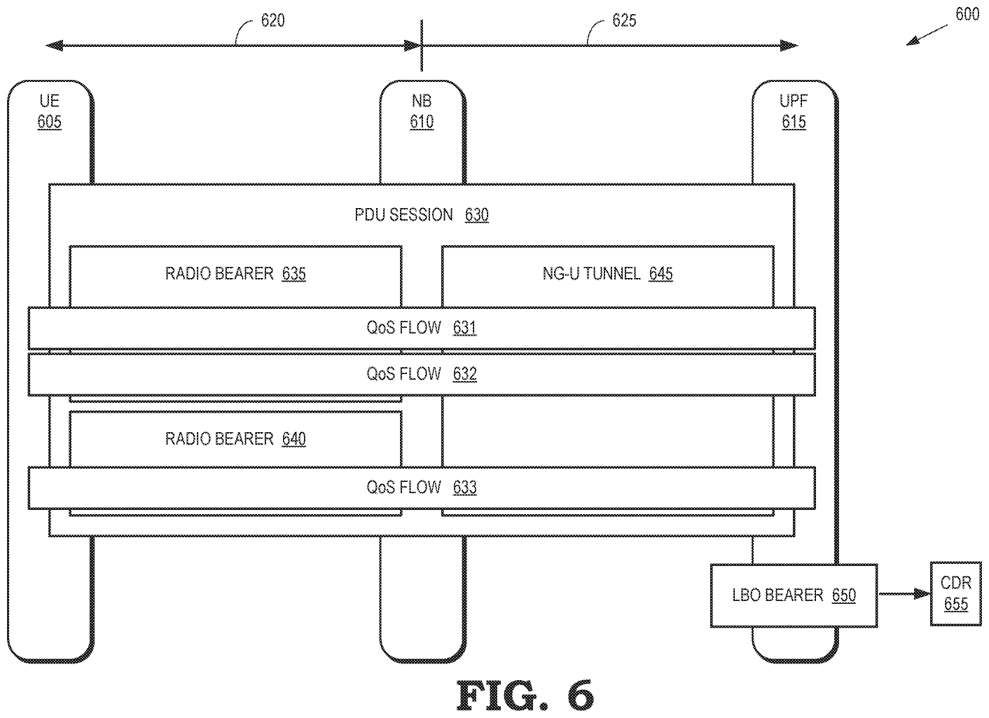

FIG. 6 is a block diagram of an LBO architecture 600 that is implemented in a 5G communication system according to some embodiments. The LBO architecture 600 is implemented in some embodiments of the 5G communication system 500 shown in FIG. 5. The LBO architecture 600 includes user equipment 605, a base station (NB) 610, and a UPF 615 that provides connectivity to one or more data networks or other UPF. The user equipment 605 and the base station 610 are part of a next-generation radio access network (NG-RAN) 620. The base station 610 and the UPF 615 are part of a 5G core network 625.

A PDU session 630 is established between the user equipment 605 and the UPF 615 to provide data connectivity for services associated with an access point name (APN). The PDU session 630 supports one or more quality-of-service (QoS) flows 631, 632, 633, which represents the finest level of granularity within the PDU session 630. In some embodiments, one of the QoS flows 631-633 is a default QoS flow for the PDU session 630. User data packets are mapped onto the QoS flows 631-633 at the user equipment 605 (for uplink packets) and at the UPF (for downlink packets). The PDU session 630 also supports one or more radio bearers 635, 640 and one or more user plane tunnels such as the NG-U tunnel 645. The user equipment 605 and the NG-RAN 620 map the QoS flows 631-633 onto the dedicated radio bearers 635, 640 based on decisions taken by the NG-RAN 620. In some embodiments, separate radio bearers 635, 640 are established for QoS flows 631-633 that require different packet forwarding treatment. Multiple QoS flows 631-633 belonging to the same PDU session 630 can also be mapped to the same radio bearer 635, 640. In the illustrated embodiment, a single tunnel 645 transports all the QoS flows 631-633 of the PDU session 630. However, in the case of dual connectivity implementations, more than one tunnel is implemented, e.g., one to a mobile network and one to a serving network.

An LBO bearer 650 is instantiated by the UPF 615. In the illustrated embodiment, the LBO bearer 650 is a unique bearer that is only known to the UPF 615. The LBO bearer 650 is not known to other elements in the 5G communication system 600. For example, the LBO bearer 650 is not known to the user equipment 605 or the base station 610. In the illustrated embodiment, the LBO bearer 650 uses the same downlink TEID as the default bearer. The UPF 615 selectively routes packets to data network via the PDU session 630 or to local applications via the LBO bearer 650, e.g., based on one or more LBO rules implemented in the UPF 615. Some embodiments of the LBO bearer 650 perform charging functions such as generating a CDR 655, legal intercept, and the like. For example, the LBO bearer 650 can generate a CDR 655 that includes information that is used to charge a user for local service or applications implemented in an MEC module.

Some embodiments of the LBO bearer 650 use the ULCL associated with received packets to map traffic including a QFI based on QFI routing rules for the PDU session 630, as well as the LBO bearer rules that are maintained locally at the UPF 615. Traffic that is routed to the default bearers 635, 640 or the tunnel 645 is sent to the original PDU session anchor (PSA) for the PDU session 630. In some embodiments, the DNAI associated with the packets is configured as an APN, which helps to resolve local breakout PSA and map a VPN context for local rules. Some embodiments of the LBO rules include trigger rules (in a trigger rule unit) that are configured in conjunction with using the DNAI (in an action rule) to associate triggers that cause UPF reselection with other triggers in conjunction with the DNAI configured in the action rule unit. This approach assists in performing reselection of a UPF or SGW-U when a change in user location information (ULI) or a trigger is reported.

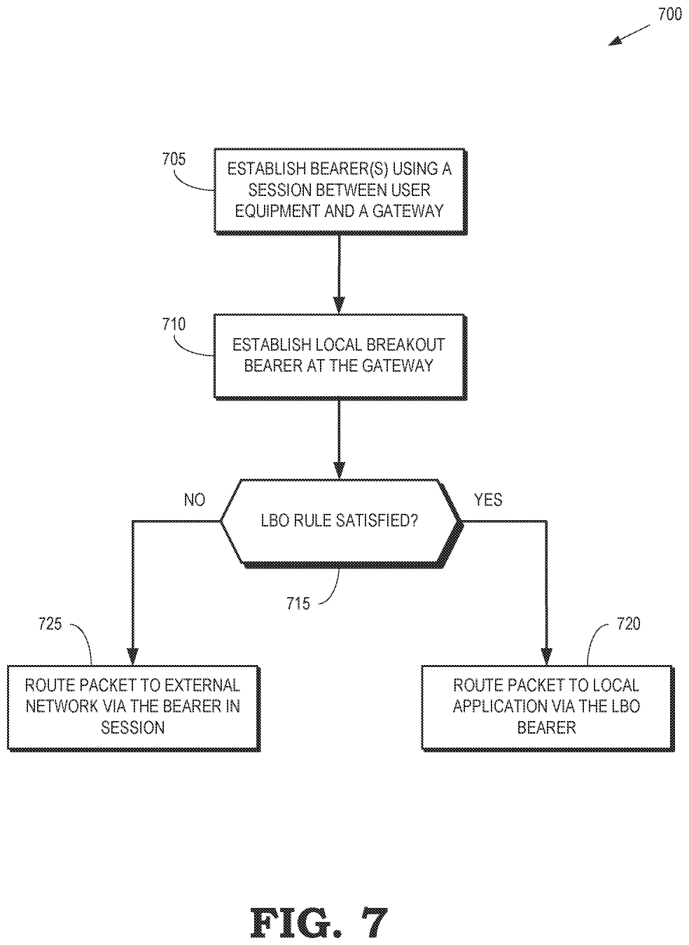

FIG. 7 is a flow diagram of a method 700 of selectively routing packets to an LBO bearer or a default bearer according to some embodiments. The method 700 is implemented in some embodiments of the communication systems 100, 200, 300, 400, 500, 600 shown in FIGS. 1-6.

At block 705, a user equipment and a gateway establish a communication session and one or more bearers supported by the communication session. In a 4G communication system, the gateway is an SGW and the communication session is a PDN session that is terminated by the user equipment and a PGW. In a 5G communication system, the gateway is a UPF and the communication session is a PDU session that is terminated by the user equipment and the UPF (or another UPF).

At block 710, the gateway establishes an LBO bearer to operate concurrently with the default bearers in the communication session. The LBO bearer is used to route packets to a local MEC application. As discussed herein, the LBO bearer supports the same functionality as the default bearers, e.g., charging, legal intercept, and the like. The gateway is therefore able to selectively route packets to the LBO bearer or one of the default bearers based on LBO rules implemented in the gateway.

At block 715, the gateway receives one or more packets and determines whether the packet satisfy an LBO rules maintain that the gateway. For example, the gateway can determine whether the packet includes a ULCL that indicates that the packet should be routed to the LBO bearer. If the one or more packets satisfy one of the LBO rules, the method 700 flows to the block 720 and the packet is routed to a local application via the LBO bearer. If the packets do not satisfy any of the LBO rules, the method 700 flows to the block 725 and the packet is routed to an external network via the default bearer in the communication session.

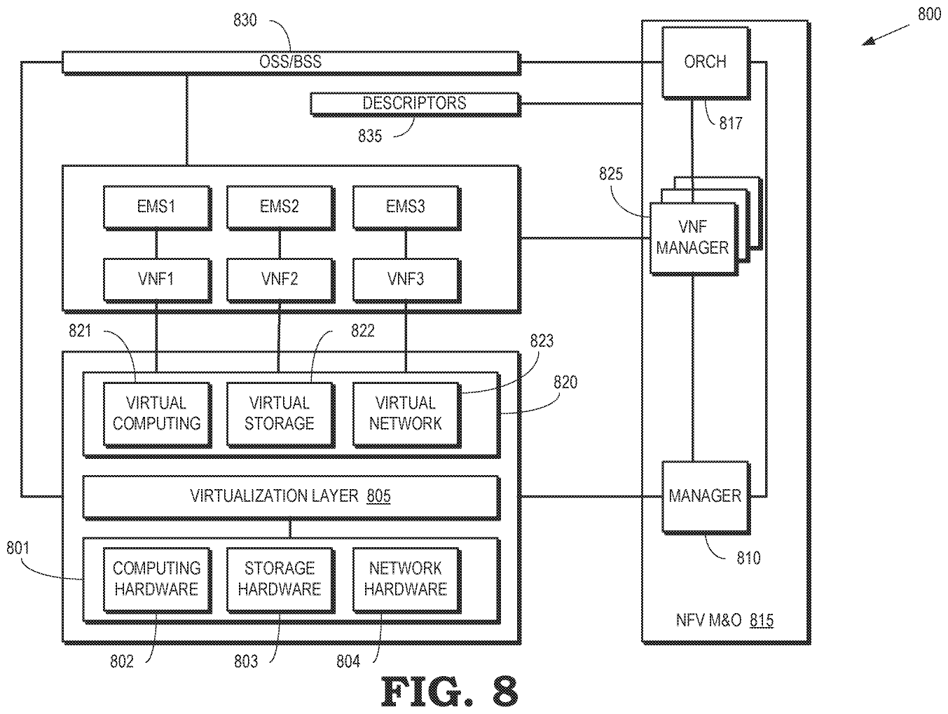

FIG. 8 is a block diagram of a network function virtualization (NFV) architecture 800 that supports LBO offload for MEC according to some embodiments. The NFV architecture 800 is used to implement some embodiments of the communication systems 100, 200, 300, 400, 500, 600 shown in FIGS. 1-6. The NFV architecture 800 includes hardware resources 801 including computing hardware 802, storage hardware 803, and network hardware 804. The computing hardware 802 is implemented using one or more processors, the storage hardware 803 is implemented using one or more memories, and the network hardware 804 is implemented using one or more transceivers, transmitters, receivers, interfaces, and the like.

A virtualization layer 805 provides an abstract representation of the hardware resources 801. The abstract representation supported by the virtualization layer 805 can be managed using a virtualized infrastructure manager 810, which is part of the NFV management and orchestration (M&O) module 815. Some embodiments of the manager 810 are configured to collect and forward performance measurements and events that may occur in the NFV architecture 800. For example, performance measurements may be forwarded to an orchestrator (ORCH) 817 implemented in the NFV M&O 815. The hardware resources 801 and the virtualization layer 805 may be used to implement virtual resources 820 including virtual computing resources 821, virtual storage resources 822, and virtual networking resources 823.

Virtual networking functions (VNF1, VNF2, VNF3) run over the NFV infrastructure (e.g., the hardware resources 1801) and utilize the virtual resources 820. For example, the virtual networking functions (VNF1, VNF2, VNF3) may be implemented using virtual machines supported by the virtual computing resources 821, virtual memory supported by the virtual storage resources 822, or virtual networks supported by the virtual network resources 823. Element management systems (EMS1, EMS2, EMS3) are responsible for managing the virtual networking functions (VNF1, VNF2, VNF3). For example, the element management systems (EMS1, EMS2, EMS3) may be responsible for fault and performance management. In some embodiments, each of the virtual networking functions (VNF1, VNF2, VNF3) is controlled by a corresponding VNF manager 825 that exchanges information and coordinates actions with the manager 810 or the orchestrator 817.

The NFV architecture 800 may include an operation support system (OSS)/business support system (BSS) 830. The OSS/BSS 830 deals with network management including fault management using the OSS functionality. The OSS/BSS 830 also deals with customer and product management using the BSS functionality. Some embodiments of the NFV architecture 800 use a set of descriptors 835 for storing descriptions of services, virtual network functions, or infrastructure supported by the NFV architecture 800. Information in the descriptors 835 may be updated or modified by the NFV M&O 815.

The NFV architecture 800 implements network slices that provide control plane functions or user plane functions. A network slice is a complete logical network that provides communication services and network capabilities, which can vary from slice to slice. User equipment can concurrently access multiple slices that support multiple service flows between a core network and the user equipment. Some embodiments of user equipment provide Network Slice Selection Assistance Information (NSSAI) parameters to the network to assist in selection of a slice instance for the user equipment. A single NSSAI may lead to the selection of several slices. The NFV architecture 1800 can also use device capabilities, subscription information and local operator policies to do the selection. An NSSAI is a collection of smaller components, Single-NSSAIs (S-NSSAI), which each include a Slice Service Type (SST) and possibly a Slice Differentiator (SD). Slice service type refers to an expected network behavior in terms of features and services (e.g., specialized for broadband or massive IoT), while the slice differentiator can help selecting among several network slice instances of the same type, e.g. to isolate traffic related to different services into different slices.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

As used herein, the term “circuitry” may refer to one or more or all of the following:
(a) hardware-only circuit implementations (such as implementations and only analog and/or digital circuitry) and
(b) combinations of hardware circuits and software, such as (as applicable):
   (i) a combination of analog and/or digital hardware circuit(s) with software/firmware and
   (ii) any portions of a hardware processor(s) with software (including digital signal processor(s), software, and memory(ies) that work together to cause an apparatus, such as a mobile phone or server, to perform various functions) and
(c) hardware circuit(s) and/or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular network device, or other computing or network device.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1-33. (canceled)

34. A method comprising:
establishing a local breakout (LBO) bearer at a gateway, wherein the LBO bearer operates concurrently with at least one bearer associated with a communication session involving a user equipment; and
selectively routing packets associated with the user equipment to the LBO bearer or the at least one bearer associated with the communication session based on at least one LBO rule implemented at the gateway.

35. The method of claim 34, wherein the LBO bearer and the at least one bearer associated with the communication session are identified by the same tunnel endpoint identifier (TEID) or QoS flow identifier (QFI).

36. The method of claim 34, wherein the gateway is a serving gateway (SGW) and the communication session is a packet data network (PDN) session, wherein the PDN session is terminated by the user equipment and a PDN gateway (PGW), and wherein establishing the LBO bearer comprises establishing the LBO bearer in a user plane bearer implemented in a user plane SGW.

37. The method of claim 34, wherein the gateway is a user plane function (UPF) and the communication session is a packet data unit (PDU) session.

38. The method of claim 37, wherein establishing the LBO bearer comprises establishing the LBO bearer as a user plane bearer implemented in the UPF that is associated with a radio access network that serves the user equipment.

39. The method of claim 38, wherein establishing the LBO bearer comprises establishing the LBO bearer in response to detecting a forwarding action rule that indicates the UPF and an interface.

40. The method of claim 37, wherein establishing the LBO bearer comprises establishing the LBO bearer as a control plane bearer implemented in a system management function (SMF) that is associated with the UPF.

41. The method of claim 34, wherein establishing the LBO bearer comprises configuring the LBO bearer with at least one LBO rule that is determined based on matching criteria for at least one of a list of mobile country codes/mobile network codes (MCC/MNC) and a data network access identifier (DNAI).

42. The method of claim 41, wherein establishing the LBO bearer comprises mapping an access point name (APN) to the LBO bearer based on the at least one of the list of MCC/MNC and the DNAI.

43. The method of claim 34, further comprising:
determining whether the at least one LBO rule is satisfied for at least one packet;
wherein determining whether the at least one LBO rule is satisfied comprises determining whether the at least one LBO rule is satisfied based on at least one of a quality of service (QoS) class identifier (QCI), a QoS flow identifier (QFI), and an uplink classifier (ULCL) associated with the at least one packet.

44. The method of claim 43, wherein selectively routing packets comprises receiving a first set of uplink packets from the user equipment and routing the first set of uplink packets to a local application via the LBO bearer in response to the first set of packets satisfying the at least one LBO rule.

45. The method of claim 44, wherein selectively routing packets comprises receiving a second set of uplink packets from the user equipment and routing the second set of uplink packets to an external network via the at least one bearer associated with the communication session in response to the second set of packets not satisfying the at least one LBO rule.

46. The method of claim 43, wherein selectively routing packets comprises receiving downlink packets from the local application and routing the downlink packets towards the user equipment via the LBO bearer in response to the downlink packets satisfying the at least one LBO rule.

47. A gateway comprising:
a processor configured to establish a local breakout (LBO) bearer that operates concurrently with at least one bearer associated with a communication session involving a user equipment, wherein
the processor is configured to selectively route packets associated with the user equipment to the LBO bearer or the at least one bearer associated with the session based on at least one LBO rule implemented at the gateway.

48. The gateway of claim 47, wherein the LBO bearer and the at least one bearer associated with the communication session are identified by the same tunnel endpoint identifier (TEID)

49. The gateway of claim 47, wherein the gateway is a serving gateway (SGW) and the communication session is a packet data network (PDN) session, wherein the PDN session is terminated by the user equipment and a PDN gateway (PGW), and wherein the processor is configured to establish the LBO bearer in a user plane bearer implemented in a user plane SGW.

50. The gateway of claim 47, wherein the gateway is a user plane function (UPF) and the communication session is a packet data unit (PDU) session; wherein the processor is configured to establish the LBO bearer as a user plane bearer implemented in the UPF that is associated with a radio access network that serves the user equipment.

51. The gateway of claim 47, wherein the processor is configured to:
determine whether the at least one LBO rule is satisfied for at least one packet;
determine whether the at least one LBO rule is satisfied based on at least one of a quality of service (QoS) class identifier (QCI), a QoS flow identifier (QFI), and an uplink classifier (ULCL) associated with the at least one packet.

52. The gateway of claim 51, further comprising:
a transceiver configured to receive a first set of uplink packets from the user equipment, and
wherein the processor is configured to route the first set of uplink packets to a local application via the LBO bearer in response to the first set of packets satisfying the at least one LBO rule;
wherein the transceiver is configured to receive a second set of uplink packets from the user equipment, and wherein the processor is configured to route the second set of uplink packets to an external network via the at least one bearer associated with the communication session in response to the second set of packets not satisfying the at least one LBO rule.

53. An apparatus comprising:
at least one processor; and
at least one memory including computer program code;
the at least one memory and the computer program code configured to, with the at least one processor, cause the apparatus at least to perform:
establishing a local breakout (LBO) bearer at a gateway concurrently with at least one bearer associated with a communication session involving a user equipment; and
selectively routing packets associated with the user equipment to the LBO bearer or the at least one bearer associated with the communication session based on at least one LBO rule implemented at the gateway.
